(19) United States
(12) Patent Application Publication
(10) Pub. No.: US 2013/0174762 A1
(43) Pub. Date: Jul. 11, 2013

(54) RECONFIGURABLE LOAD-BEARING ARTICLE

(71) Applicants: David Hedley, Ameliasburg (CA); Thomas Bohan, Westlake, OH (US)

(72) Inventors: David Hedley, Ameliasburg (CA); Thomas Bohan, Westlake, OH (US)

(73) Assignee: NOVO FOAM PRODUCTS LLC, Westlake, OH (US)

(21) Appl. No.: 13/822,953

(22) PCT Filed: Apr. 16, 2012
(86) PCT No.: PCT/US12/33775

§ 371 Date: Mar. 13, 2013

Related U.S. Application Data
(60) Provisional application No. 61/475,746, filed on Apr. 15, 2011.

(51) Int. Cl. B65D 19/00; B23P 19/04; B65D 19/40

(52) U.S. Cl. CPC B65D 19/0026; B65D 19/40; B23P 19/04; B65D 2519/00104; B65D 2519/00034; B65D 2519/00288; B65D 2519/00323; B65D 2519/00736
USPC 108/50.11; 108/57.33; 108/57.25; 29/428

(57) ABSTRACT

The present application is directed to a reconfigurable load-bearing article (10) including a deck unit (12) and at least two supports (14) configured to be coupled to the deck unit, the supports including at least one spacer receiving member configured to receive and releasably engage a spacer (16). The load-bearing article is reconfigurable to form any suitable load- bearing article and may be used to provide a lightweight, durable, strong, multipurpose pallet having a four-way forklift entry.

### FIELD OF INVENTION

The present invention relates generally to load-bearing articles, and more particularly to reconfigurable load-bearing articles.

### BACKGROUND

Pallets for supporting and moving various types of articles are well known. Most pallets are designed for use with standard forklift trucks and crane lift cradles and are used throughout the world for the storage and transportation of goods. Many of the pallets in use worldwide are manufactured primarily from wood.

Wood is easy to work with, inexpensive, and well known in the warehousing and transportation industries. These properties account for the widespread use of wood in the manufacture of pallets. However, the use of wood in the manufacture of pallets does have some drawbacks. For example, wooden pallets absorb moisture, rot, splinter, and may harbor pests. The propensity of wooden pallets to harbor pests means that wooden pallets may inadvertently transport harmful fungi, bacteria, and insects between different eco-systems. The introduction of pests into a local eco-system via wooden packing materials, including wooden pallets, can have devastating effects on the local ecosystem.

Conventional pallets, whether made of wood or other materials, typically are manufactured for a specific purpose, and with a set configuration for the desired purpose.

### SUMMARY OF INVENTION

The present application is directed to a reconfigurable load-bearing article including a deck unit and at least two supports configured to be coupled to the supports. The load-bearing article is reconfigurable to form any suitable load-bearing article and may be used to provide, for example, a lightweight, durable, strong, multipurpose pallet having a four-way forklift entry.

In particular, the reconfigurable load-bearing article includes a deck unit, and at least two supports configured to be coupled to the deck unit, the supports including at least one spacer receiving member configured to receive and releasably engage a spacer approximately perpendicular to the supports, wherein the at least two supports at least partially include a polymer.

The at least two supports may be parallel to and laterally spaced apart from one another.

The reconfigurable load-bearing article may additionally include the at least one spacer, wherein the at least one spacer includes a coupling member configured to be coupled to the spacer receiving member.

The reconfigurable load-bearing article may be configured to provide an edge-rackable load bearing to weight ratio of at least 100 to 1.

According to another aspect of the application, a method of making a reconfigurable load-bearing article includes coupling a deck unit to first and second supports that are parallel to and laterally spaced apart from one another, and coupling a plurality of spacers between and approximately perpendicular to the first and second supports, wherein the plurality of spacers are parallel to and laterally spaced apart from one another.

The foregoing and other features of the invention are hereinafter described in greater detail with reference to the accompanying drawings.

### BRIEF DESCRIPTION OF THE DRAWINGS

FIG. 1 is a top perspective view of an exemplary reconfigurable load-bearing article in accordance with the invention;

FIG. 2 is a bottom perspective view of the reconfigurable load-bearing article of FIG. 1;

FIG. 3 is a side view of the reconfigurable load-bearing article of FIG. 1 invention;

FIG. 4 is a bottom view of the reconfigurable load-bearing article of FIG. 1 invention;

FIG. 5 is a top perspective view of an exemplary support of the reconfigurable load-bearing article;

FIG. 6 is a top view of the support of FIG. 5;

FIG. 7 is a side view of the support of FIG. 5;

FIG. 8 is a bottom view of the support of FIG. 5;

FIG. 9 is a top perspective view of an exemplary spacer of the reconfigurable load-bearing article;

FIG. 10 is a top view of the spacer of FIG. 9;

FIG. 11 is a side view of the spacer of FIG. 9;

FIG. 12 is a bottom view of the spacer of FIG. 9;

FIG. 13 is a top perspective view of the reconfigurable load-bearing article of FIG. 1 with a deck unit removed;

FIG. 14 is a top perspective view of another exemplary reconfigurable load-bearing article with a deck unit removed;

FIG. 15 is a top view of the reconfigurable load-bearing article of FIG. 14;

FIG. 16 is a top perspective view of yet another exemplary reconfigurable load-bearing article;

FIG. 17 is a bottom perspective view of the reconfigurable load-bearing article of FIG. 16;

FIG. 18 is a bottom view of the reconfigurable load-bearing article of FIG. 16;

FIG. 19 is a top perspective view of a further exemplary reconfigurable load-bearing article;

FIG. 20 is a bottom perspective view of the reconfigurable load-bearing article of FIG. 19; and

FIG. 21 is a bottom view of the reconfigurable load-bearing article of FIG. 19.

### DETAILED DESCRIPTION

The principles of the present application have particular application to load-bearing articles, such as pallets, and thus will be described below chiefly in this context. The pallets can be configured/reconfigured in any suitable manner to form various pallet designs. For example, the pallets or component parts of the pallets can be configured/reconfigured as slave board pallets, slip sheet pallets, light weight airfreight pallets, general purpose pallets, full four-way-entry pallets, rack-able pallets, picture frame pallets, cruciform pallets, etc.

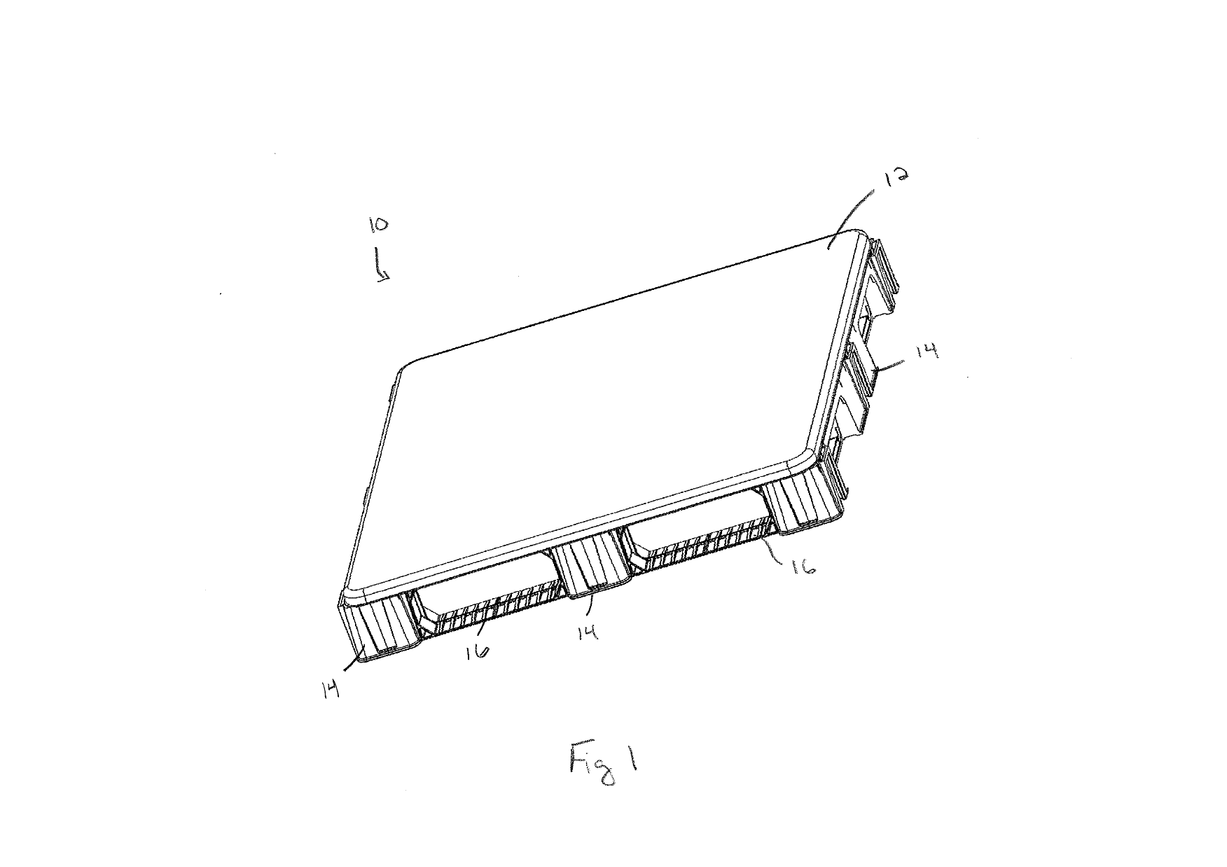

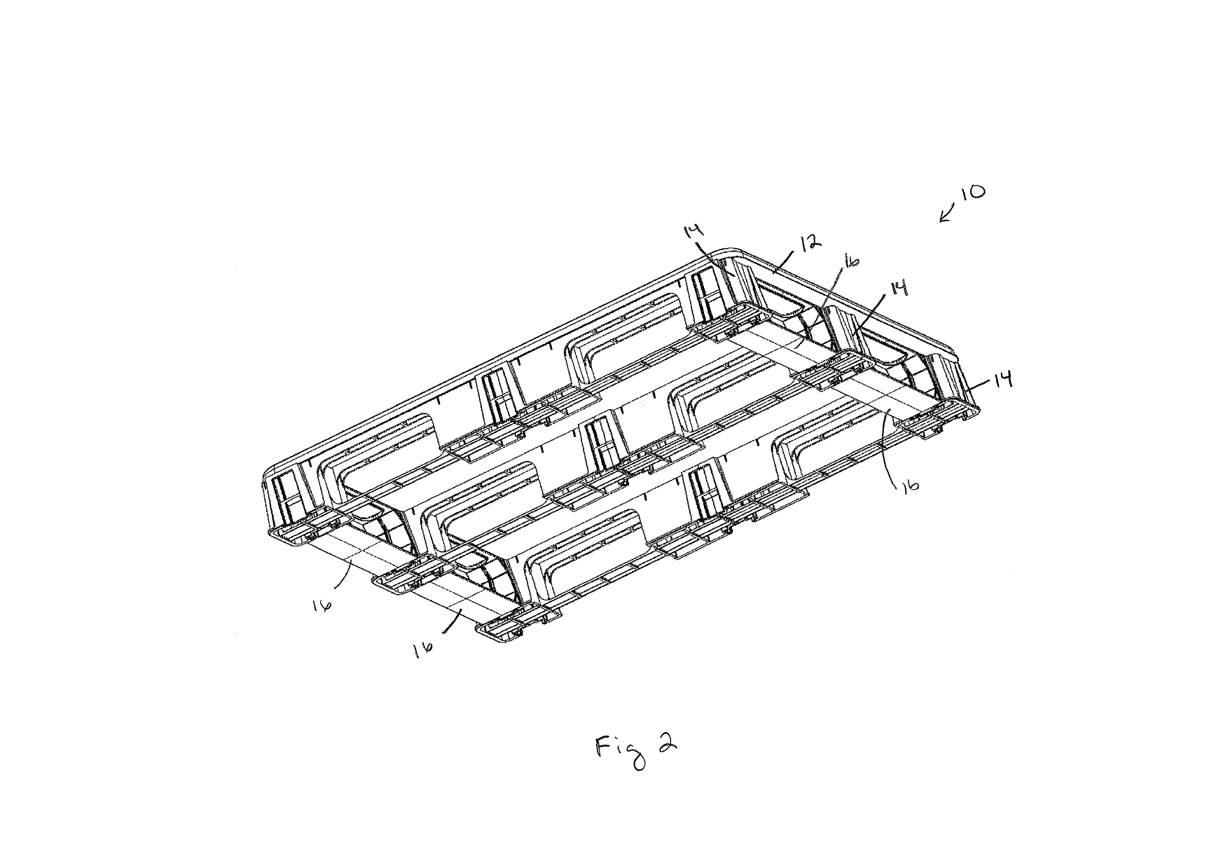

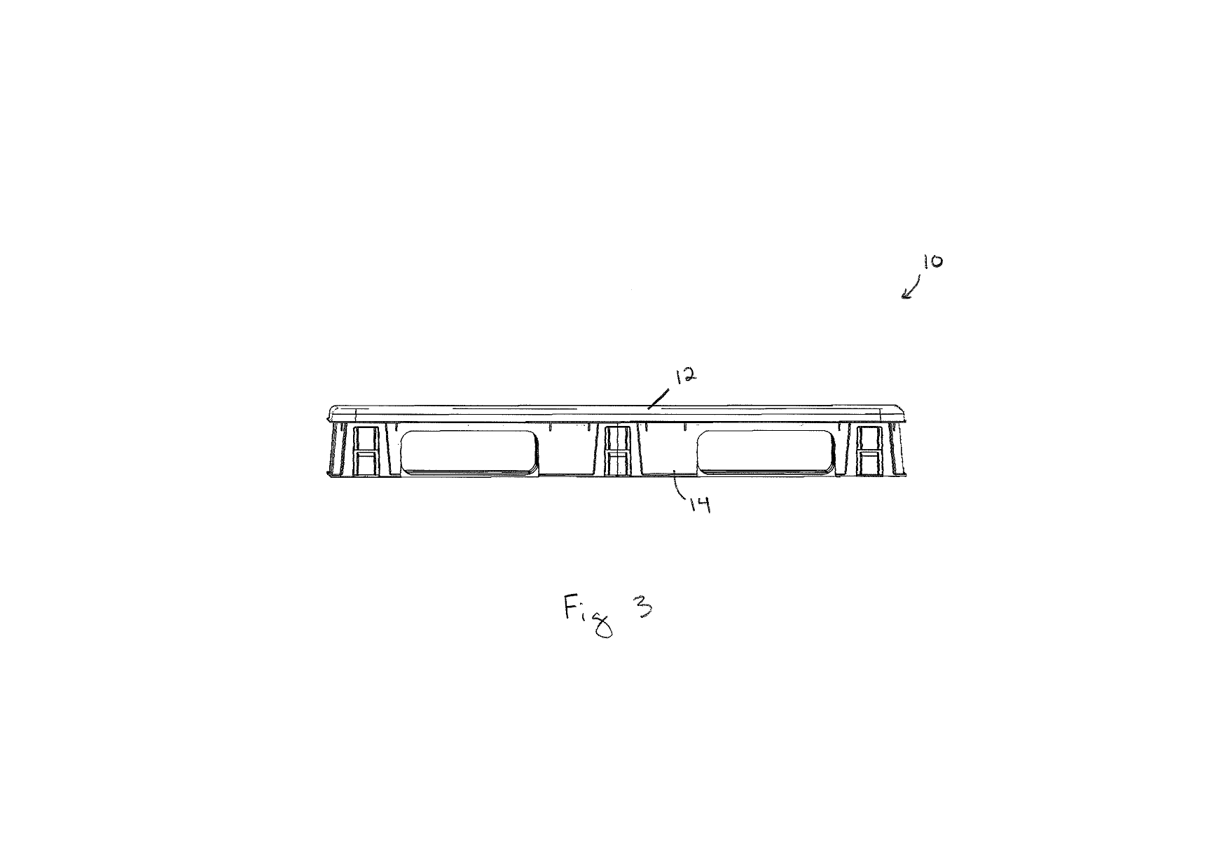

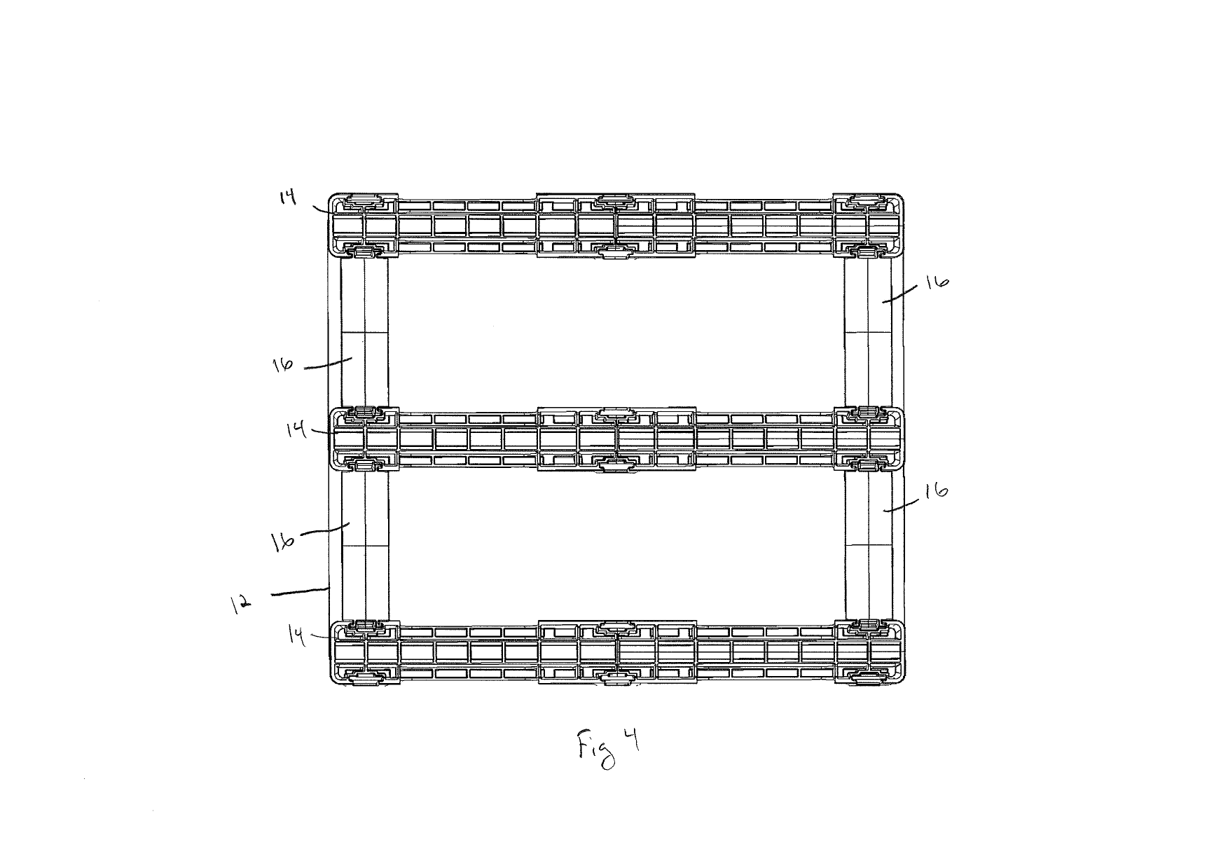

Turning now to the drawings, and initially to FIGS. 1-4, an exemplary reconfigurable load-bearing article 10 in the form of a pallet is shown. The pallet 10 may include a deck unit (also referred to simply as a deck) 12 and at least two supports 14 removably or unremovably coupled to the deck unit. The supports 14 may be coupled to the deck unit 12 by any suitable means, such as by fasteners, adhesives, male/female connectors, welding, etc. The pallet may also include a plurality of spacers 16 that may be received by the supports 14 at a position approximately perpendicular to the supports.

The deck unit 12 may be made of any suitable material, such as a compressible foam core (for example a HDPE and Arcel (PSPE) foam core) with a thermoplastic external shell, and formed by any suitable means, for instance, by using the method disclosed in U.S. Pat. No. 7,413,698 or U.S. Pat. No. 7,837,923, which are incorporated herein by reference. Although the deck may be any suitable size, in an exemplary embodiment, the deck may have a length of approximately 1 meter, a width of approximately 1.2 meters, and a thickness of approximately 25 millimeters to approximately 30 millimeters. The deck 12 may include one or more Radio-frequency identification (RFID) tags that may be attached to the deck by any suitable means and/or molded or otherwise incorporated into the deck. Additionally or alternatively, one or more RFID tags may be attached to or molded or otherwise incorporated into the supports 14 and/or spacers 16. Moreover, the deck unit 12 may be slotted to allow for ventilation and may include a plurality of hand holes for handling of the deck unit. It will be appreciated that the deck unit 12 may be used alone as a slip sheet or converted into a pallet by coupling the deck unit to two or more supports.

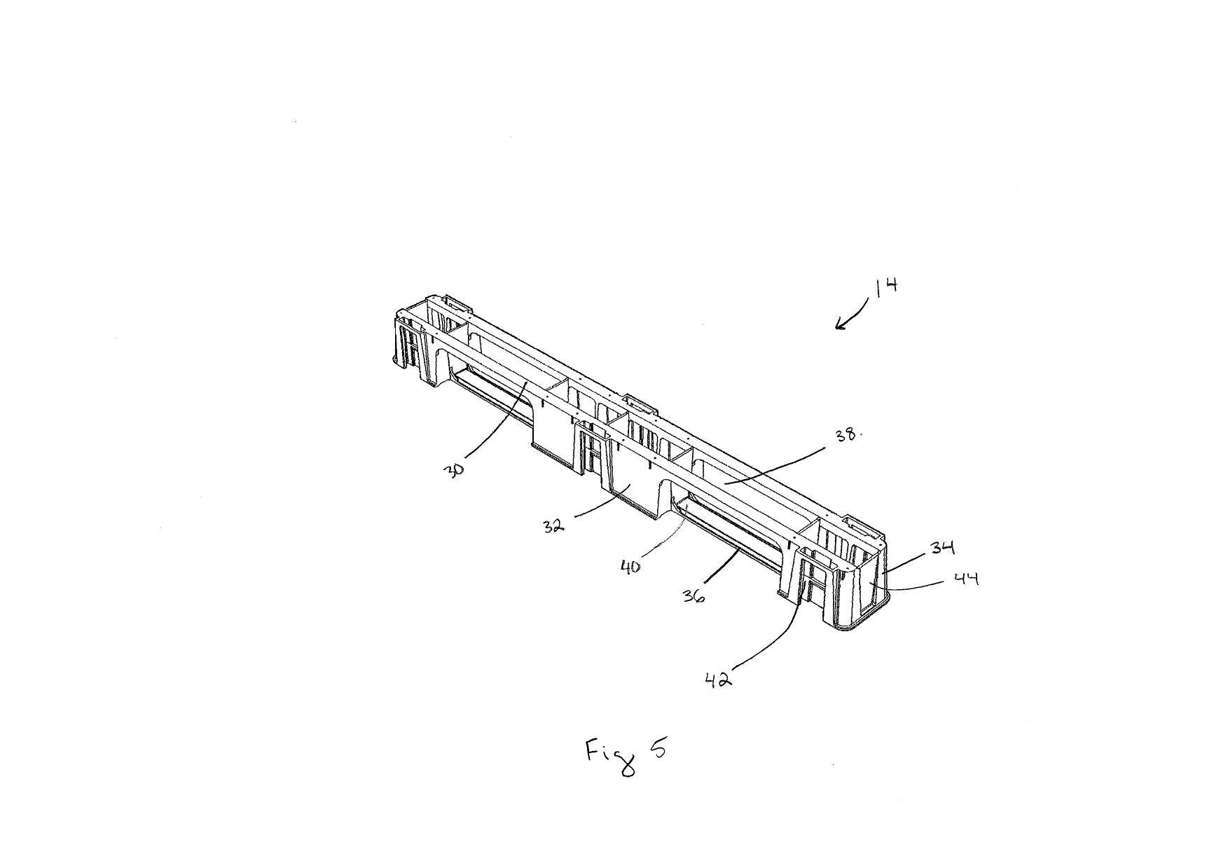

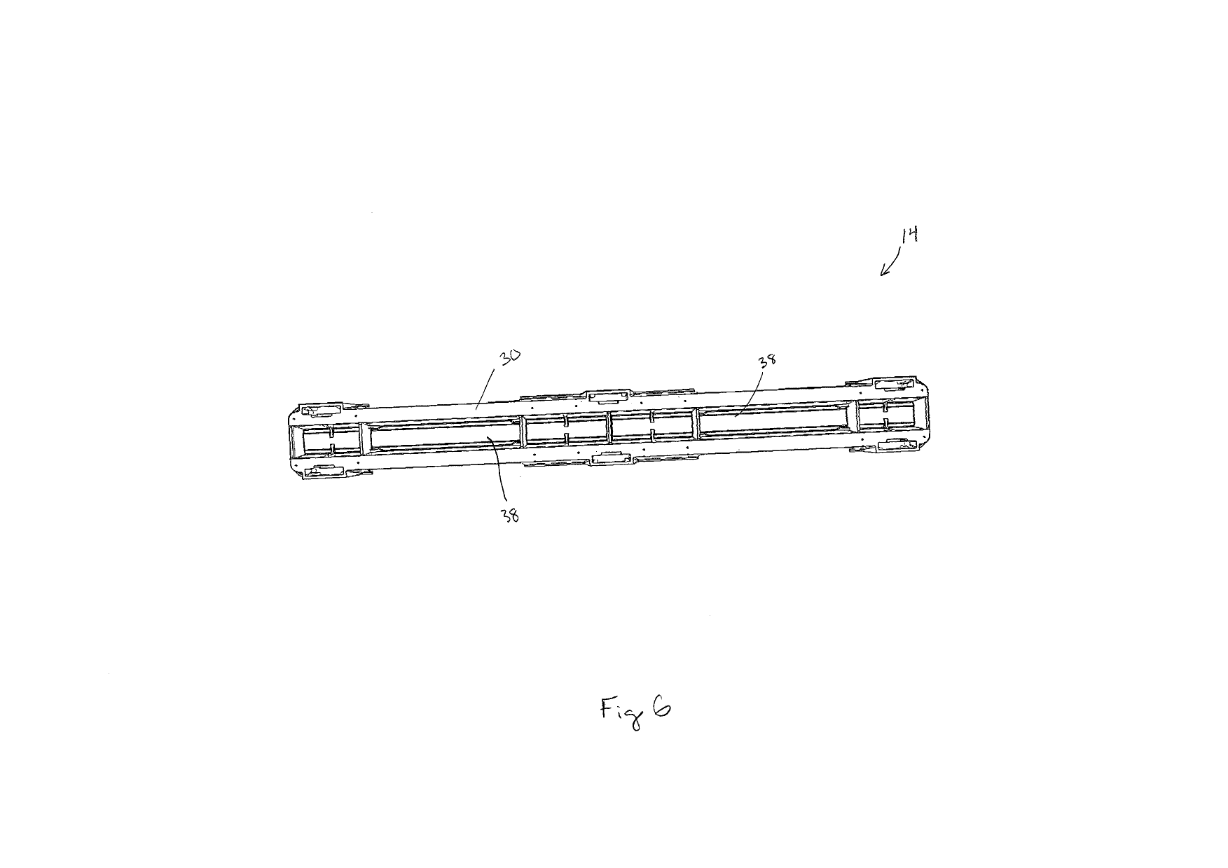

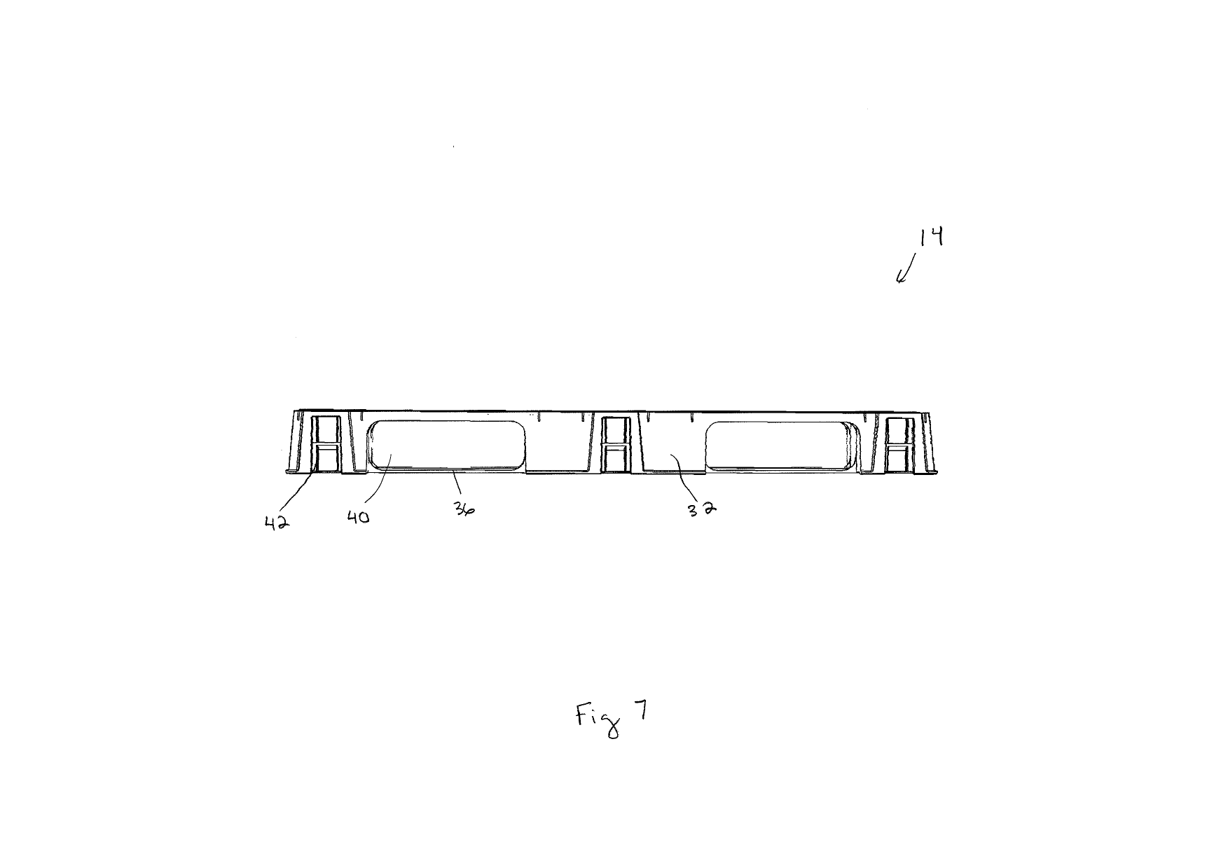

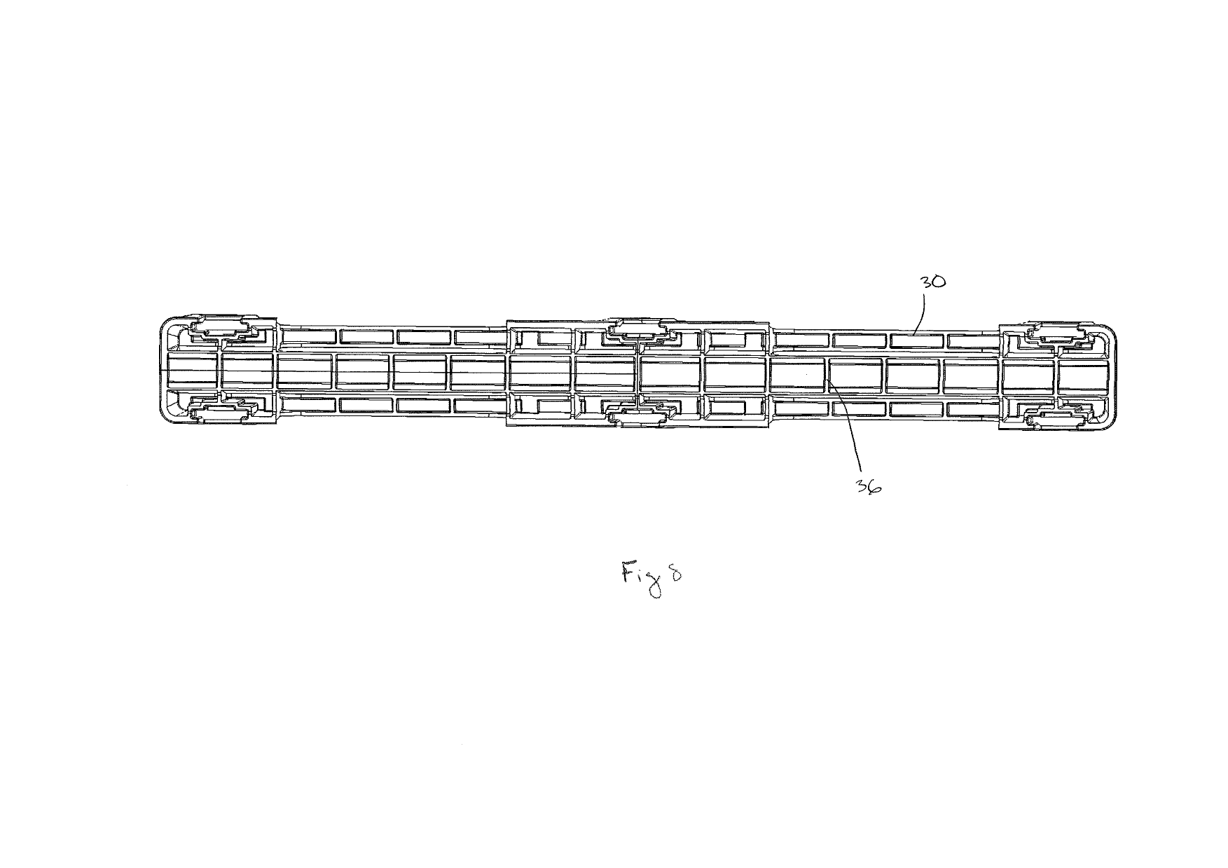

Turning now to FIGS. 5-8, the exemplary support 14 is shown in detail. The support may be made of any suitable material, such as a polymer, a metal-reinforced polymer, metal, solid or structural foam consisting of HDPE or other polyolefin and blowing agent, etc., and may be formed by any suitable means, such as by injection molding. If the support is made of a polymer, the support may be welded to the deck unit 12 by plastic welding, e.g., the support may be bonded to the deck using heat and pressure. Alternatively, the support 14 may be removably or unremovably coupled to the deck via any suitable mechanical fastener. The support 14 may include barcodes on one or more surfaces of the supports for identification during use. It will also be appreciated that barcodes may be additionally or alternatively included on the spacers and/or deck unit.

The support includes a substantially flat top portion 30, a pair of side portions 32, a pair of end portions 34 and a bottom portion 36. The top portion 30 is configured to abut a bottom of the deck unit 12 when coupled together, and may include a plurality of openings 38 that are provided to reduce the weight of the support. Alternatively, the top portion 30 may be formed without openings, which would increase the weight of the support but would also provide a larger surface area to which the deck unit 12 can be coupled.

The pair of side portions 32 may include a plurality of openings 40 that are provided to reduce the weight of the support and also to provide an area through which a forklift fork may be received. The openings 40 may be chamfered or otherwise angled to allow for easy entry of the forks. Alternatively, the side portions 32 may be formed without openings, except for the openings provided to receive a forklift fork, which would increase the weight of the support but would allow more weight to be supported by the pallet. The side portions 32 also include a plurality of spacer receiving members 42 each configured to receive a spacer 16 approximately perpendicular to the support 14. The spacer receiving members 42 may be molded to the side portion 32 or may be coupled to the side portion by suitable fasteners. The spacer receiving members 42 are also configured to receive a coupler (not shown) approximately perpendicular to the support 14 to couple the pallet 10 to another exemplary pallet. Similarly, the pair of end portions 34 each include a coupler receiving portion 44 configured to receive a coupler (not shown) to couple the pallet 10 to another exemplary pallet.

The bottom portion 36, which runs the length of the support, may be at least partially indented for pallet nesting when stacked. The bottom portion, along with bases of the side portions 32 and end portions 34, are substantially flat to rest on a floor, another pallet, etc., to allow the pallet 10 to be level.

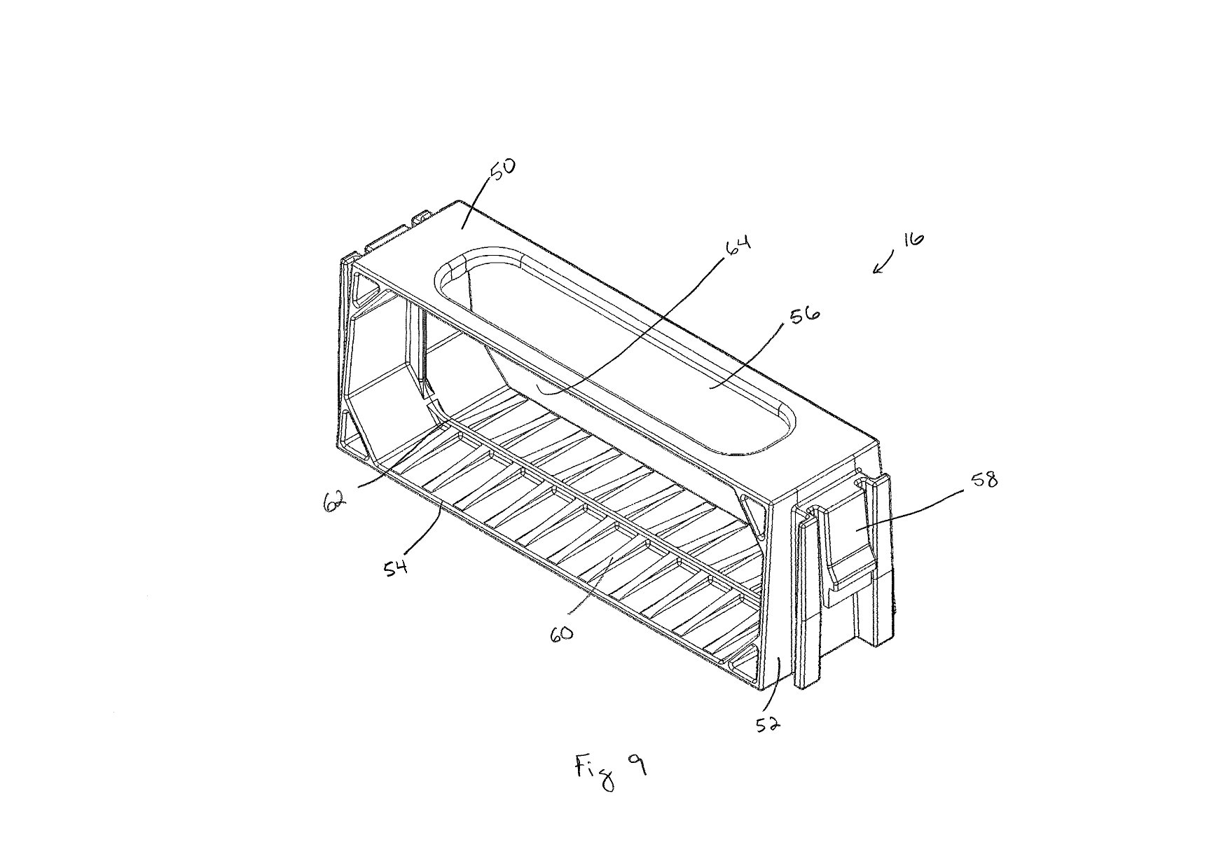

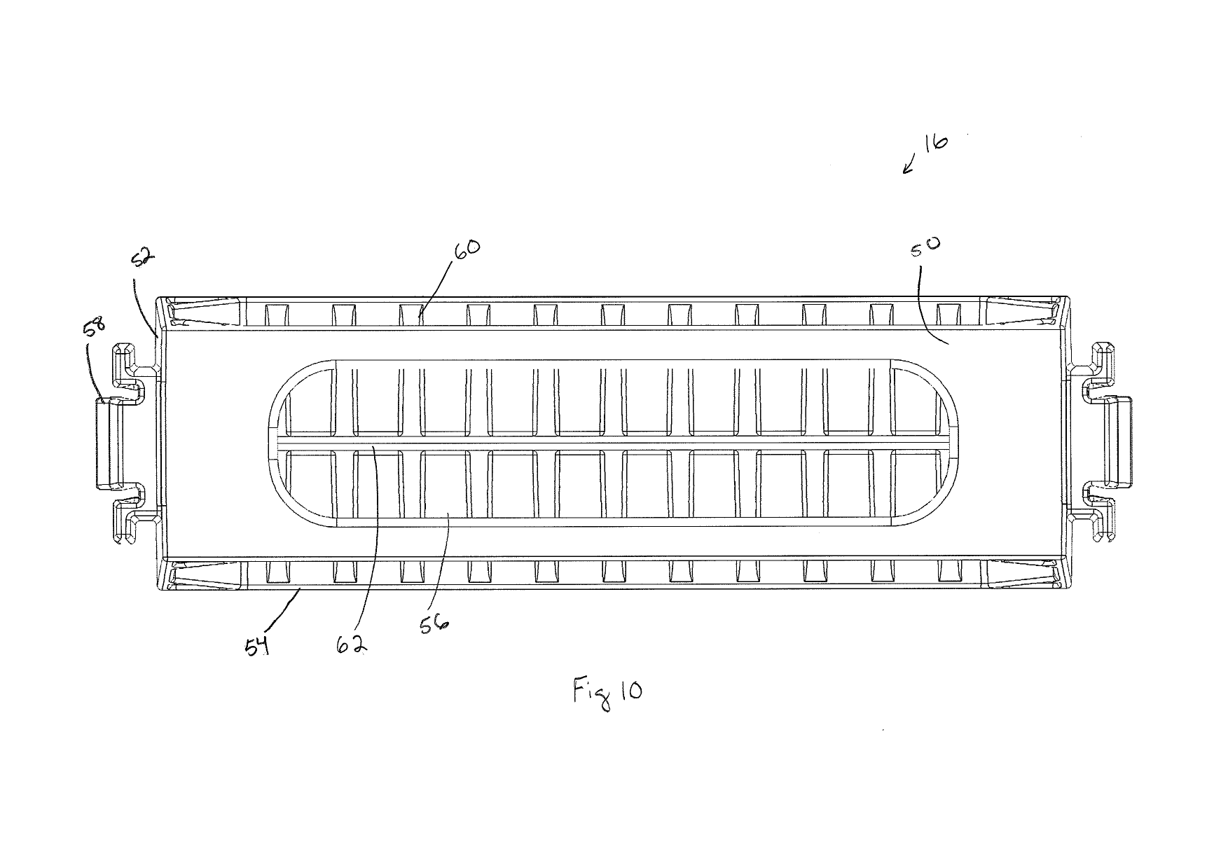

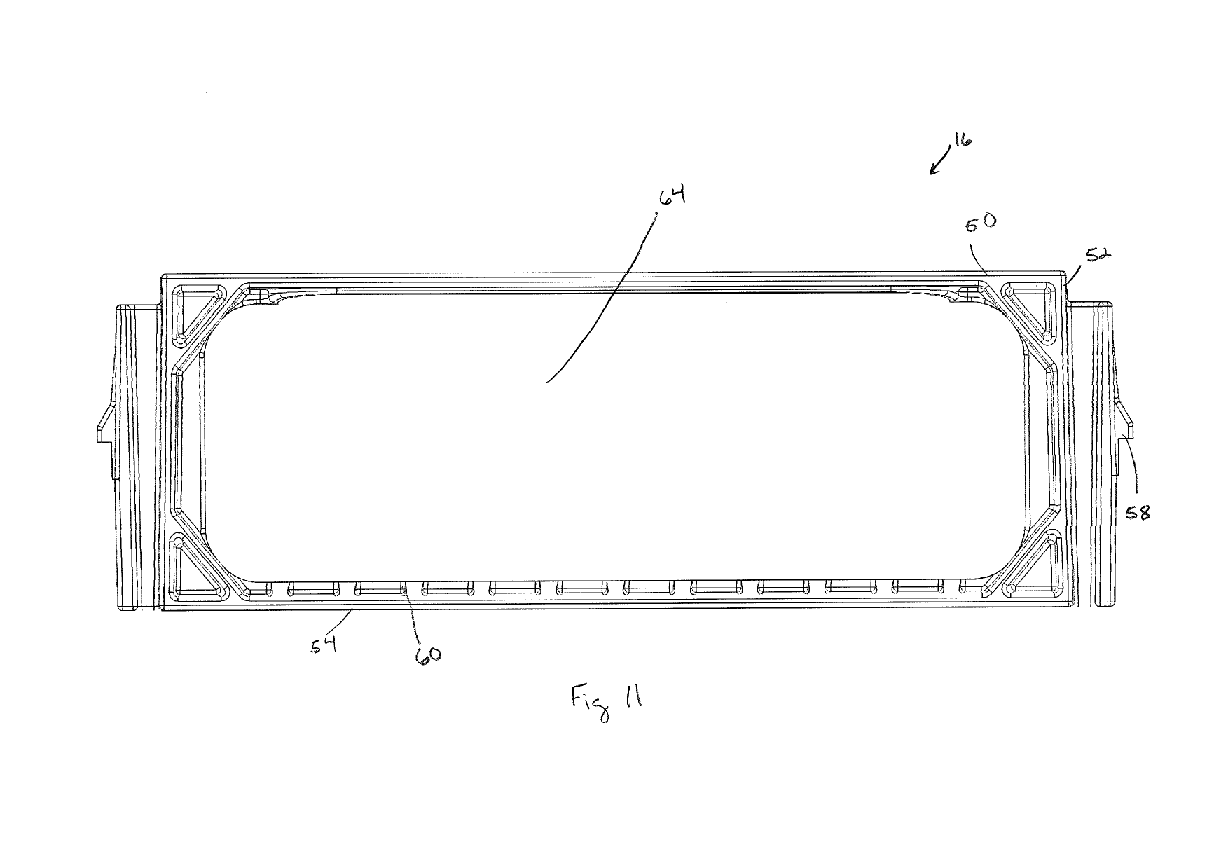

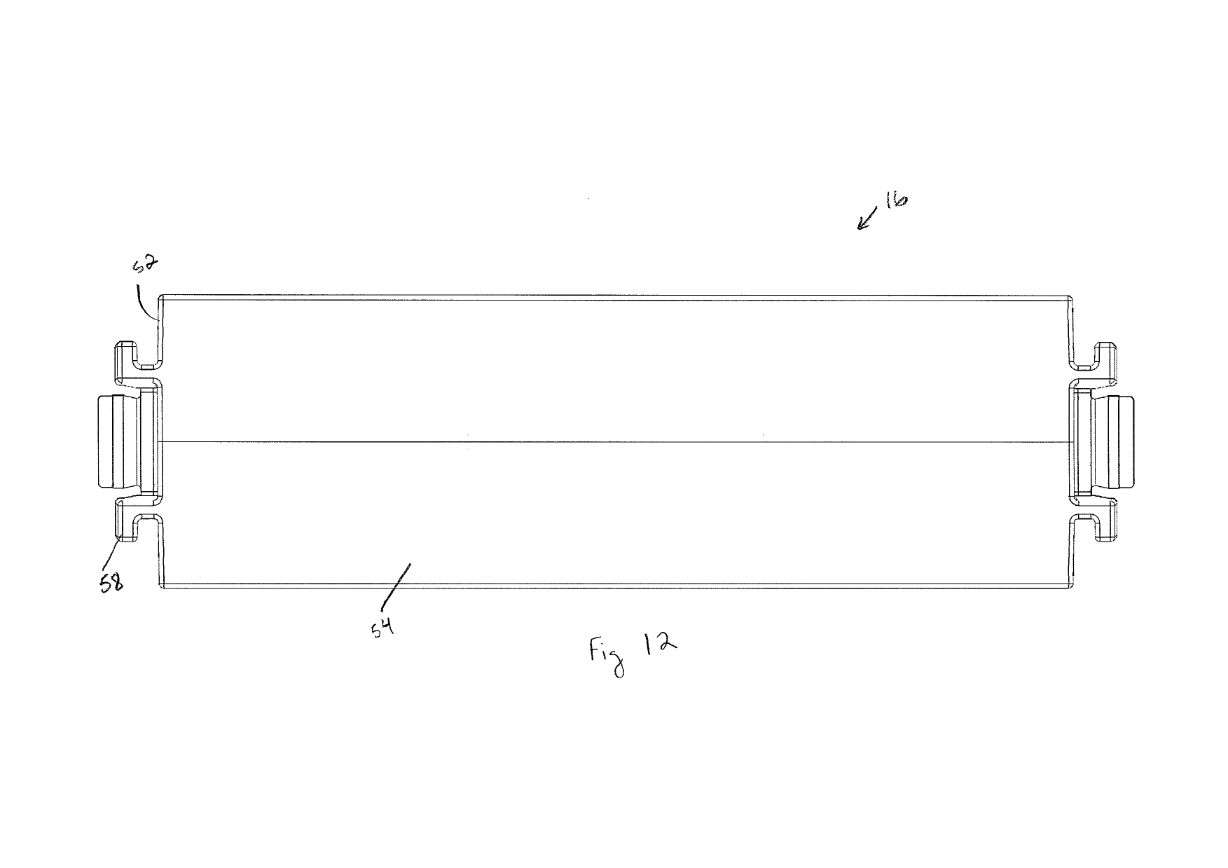

Turning now to FIGS. 9-12, the exemplary spacer 16 is shown in detail. The spacer may be made of any suitable material, such as a polymer, a metal-reinforced polymer, solid or structural foam consisting of HDPE or other polyolefin and blowing agent, etc., and may be formed by any suitable means, such as by injection molding. The spacer 16 includes a substantially flat top portion 50, a pair of end portions 52, and a bottom portion 54. The top portion 50 is configured to abut a bottom of the deck unit 12 when the supports 14 are coupled to the deck unit. The top portion 50 may include at least one opening 56 that is provided to reduce the weight of the spacer. Alternatively, the top portion 50 may be formed without the at least one opening 56, which would increase the weight of the spacer but would also provide a larger surface area to support the deck unit 12.

The pair of end portions 52 include a coupler member 58 configured to be received by the spacer receiving members 42. In the illustrated embodiment, the coupler member 58 is a male coupler and the spacer receiving member 42 is a female coupler, although it will be appreciated that the coupler member 58 may be a female coupler and the spacer receiving member 42 may be a male member. The bottom portion 54, which is substantially flat to rest on a floor, another pallet, etc., may be at least partially indented for pallet nesting when stacked. The bottom portion 54 includes a plurality of ribs 60 supporting a support member 62 running the length of the spacer to provide additional support to the end portions 52.

The spacer 16 further includes an opening 64 on each side of the spacer that is provided to reduce the weight of the spacer. Alternatively, the spacer may be formed with side portions that may or may not include at least one opening. The side portions would increase the weight of the spacer but would provide additional support to the top portion 50 and the end portions 52.

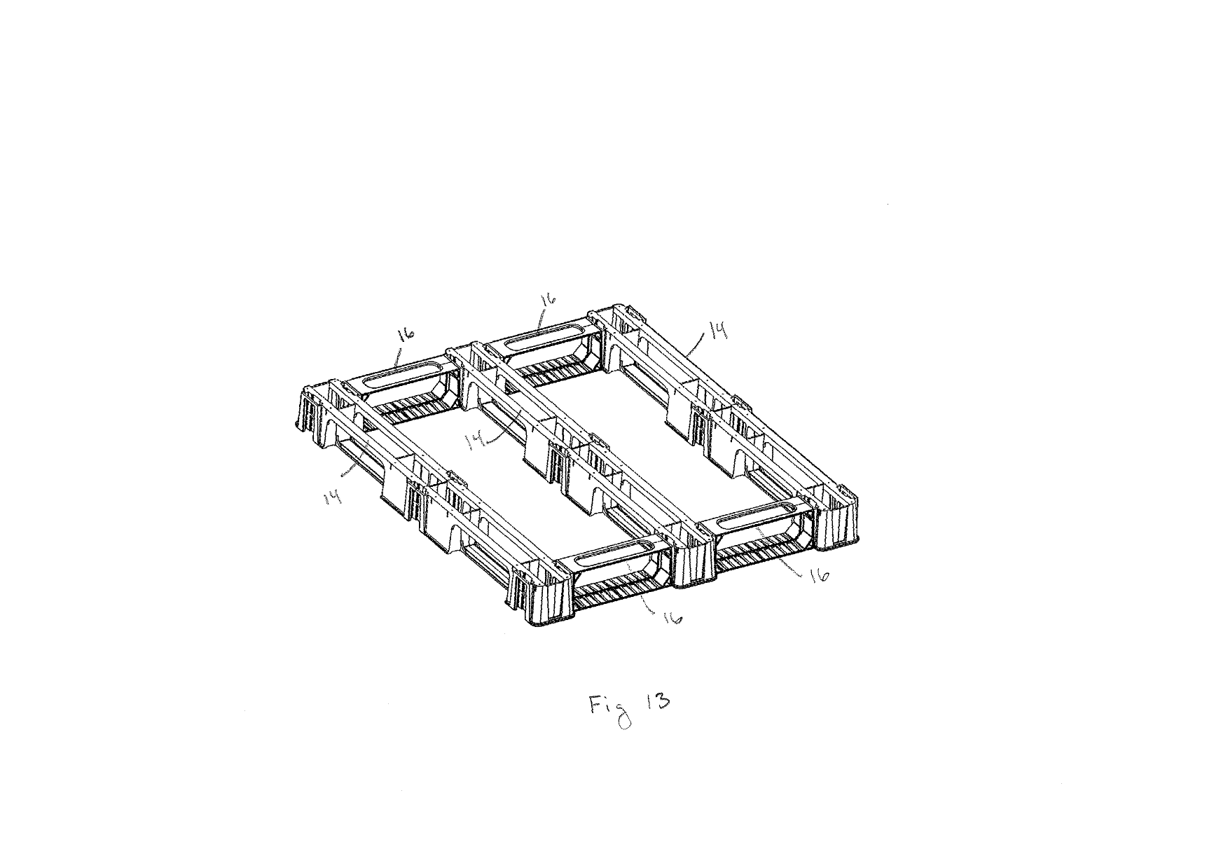

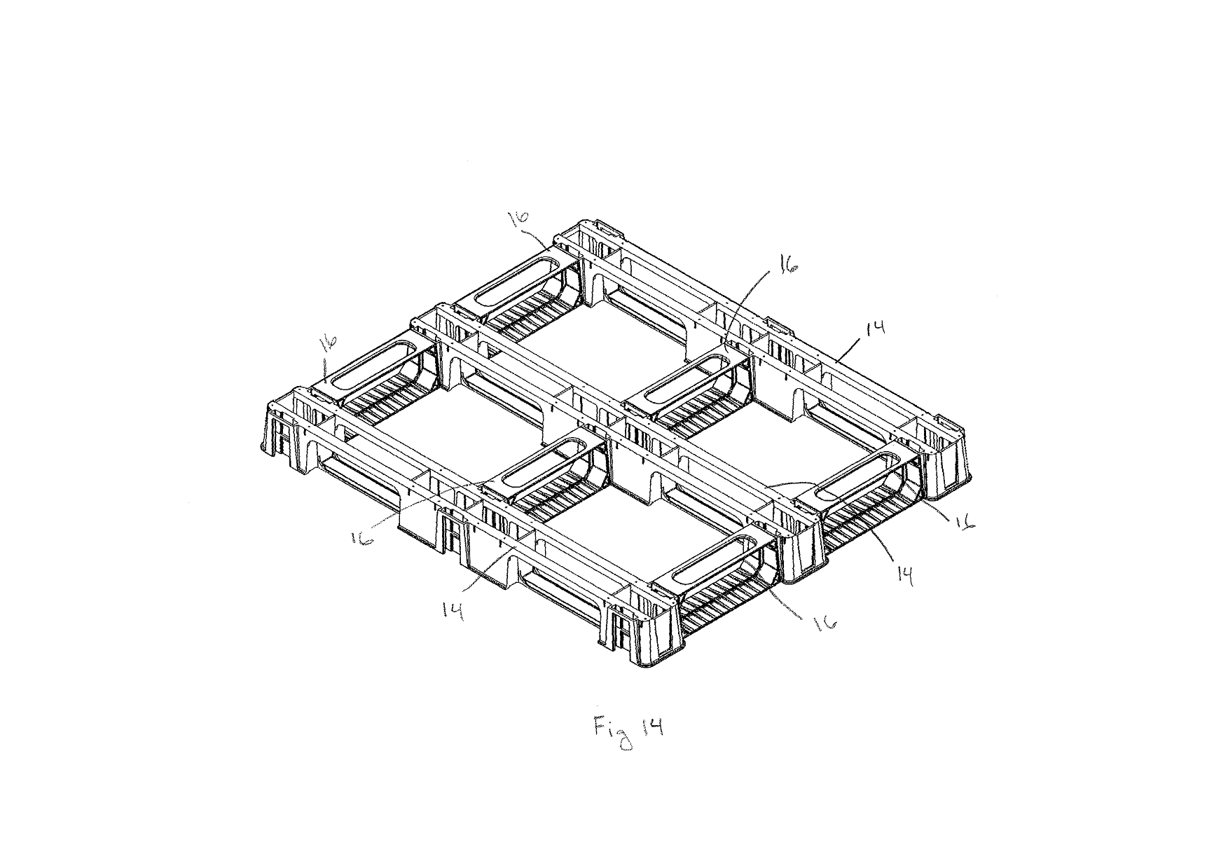

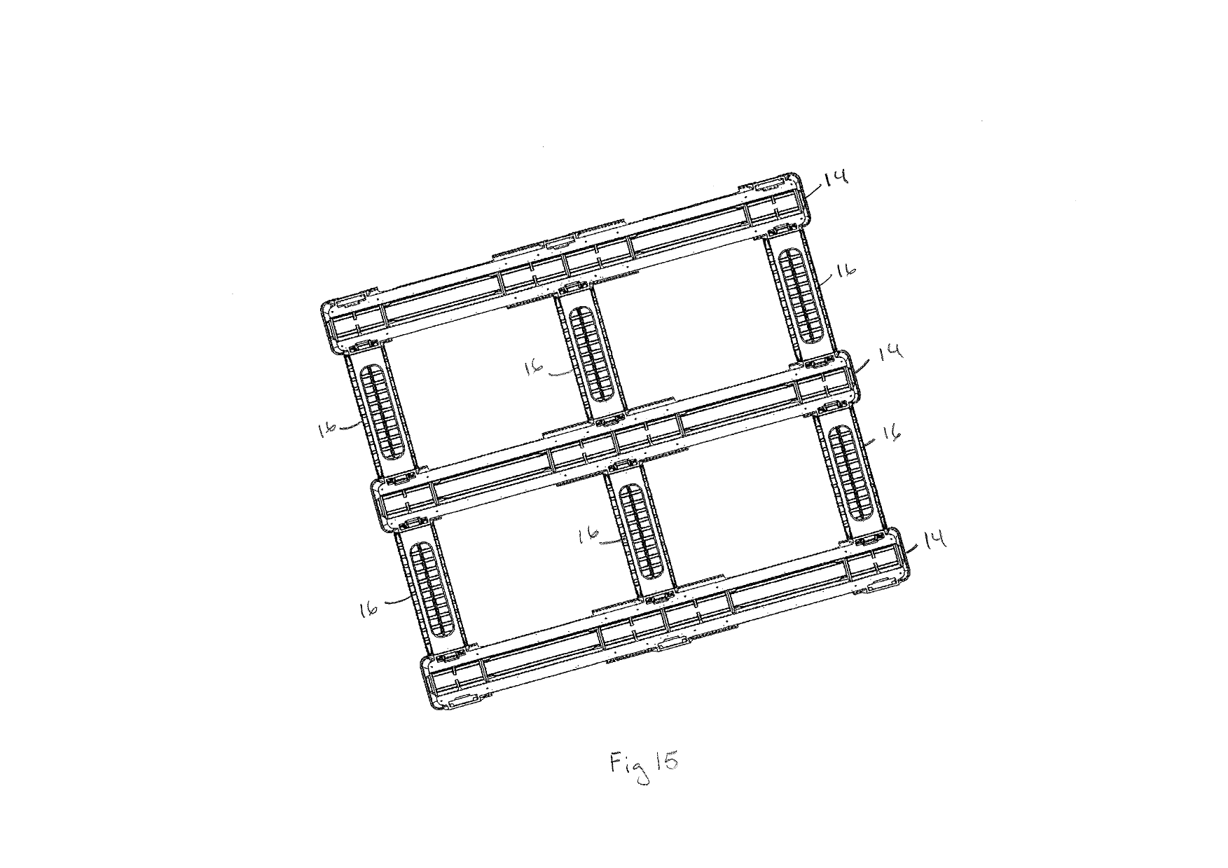

Turning now to FIG. 13, the exemplary pallet is shown with the deck unit 12 removed. In this exemplary embodiment, the pallet 10 includes three supports 14 and four spacers 16 that are coupled as described above, thereby forming a picture frame type pallet. FIGS. 14 and 15 also illustrate a pallet with the deck unit removed, similar to FIG. 13, except the illustrated pallet includes three supports 14 and six spacers 16, thereby forming a cruciform type pallet.

To construct the above-described pallet 10, the supports 14 are positioned parallel to and laterally spaced apart from one another and are coupled to the deck unit 12 as described above. Then, the desired number of spacers 16 are coupled to the supports 14, for example by sliding the coupler members 58 into the spacer receiving members 42. The pallet may be reconfigured to adjust the number of spacers. For example, the pallet 10 may be configured with four spacers to form a picture frame type pallet and then two additional spacers may be added to form a cruciform type pallet. The number of spacers used in a pallet may be increased or decreased to increase/decrease the surface area of the bottom of the pallet. The cruciform type pallets, for example, which can be used in ground domestic transportation, have a larger bottom surface area than picture frame type pallets and therefore provide more load distribution. Although the spacers 16 have been described as being coupled to the supports 14 after the supports and deck unit 12 are coupled, it will be appreciated that the spacers 16 may be coupled to the supports 14 prior to the supports being coupled to the deck unit 12, and the spacers may also be coupled to the deck unit in a similar manner as the supports.

It will now be appreciated that once the pallet is constructed, a lightweight, durable, strong, multipurpose pallet may be provided that has a four-way forklift entry. The pallet is designed to not absorb liquids, be impervious to infestation, and to be recyclable. Moreover, the pallet can be configured and reconfigured as described above in any suitable manner based on the intended use of the pallet. Further, once constructed, the pallet 10 may be any suitable weight which may be varied based on the intended use of the pallet. For example, the pallet 10 may include fewer supports/spacers when supporting lighter loads and more supports/spacers when supporting heavier loads. It will be appreciated that, regardless of the desired configuration, the pallet herein described provides considerable load capacity with a greatly-reduced weight relative to conventional pallets. In one embodiment, a pallet having three supports may have a total weight of about twenty-five pounds, with or without spacers, and may be configured to support an edge-rackable load of approximately 2800 pounds. The pallet therefore would be configured to provide an edge-rackable load bearing to weight ratio of at least 100 to 1. This strength-to-weight ratio of at least 100 to 1 can be compared to a strength-to-weight ratio of about 50 to 1 or less with conventional pallets.

In addition to being used to support and transport articles, the pallets may be coupled together to form a floor, a wall, or other composite structure. An exemplary use as a floor will now be described. A plurality of pallets may be loaded with supplies at location A in a first country and shipped to location B in a second country, for example for medical aid use by a military. Once the supplies have been unloaded (or even prior to unloading), the pallets can be coupled together to form a floor for an operating room or another application. This is advantageous in that a sturdy, level floor may be provided that is elevated off of the ground. If such elevation is not desired, the deck units 12 may be removed from the supports 14 and the spacers 16 and abutted against one another to form a sturdy, level floor.

Moreover, in another exemplary embodiment, the pallets 10 may be manufactured at a first location for Company A. The pallets may be shipped from the first location with Company B's product thereon to a second location, preferably in the vicinity of Company A. After Company B's products have been unloaded, the pallets are delivered to Company A. In this way, Company B may be provided with use of pallets at little to no cost while Company A may receive its pallets without having to pay for shipping costs from the first location to the second location.

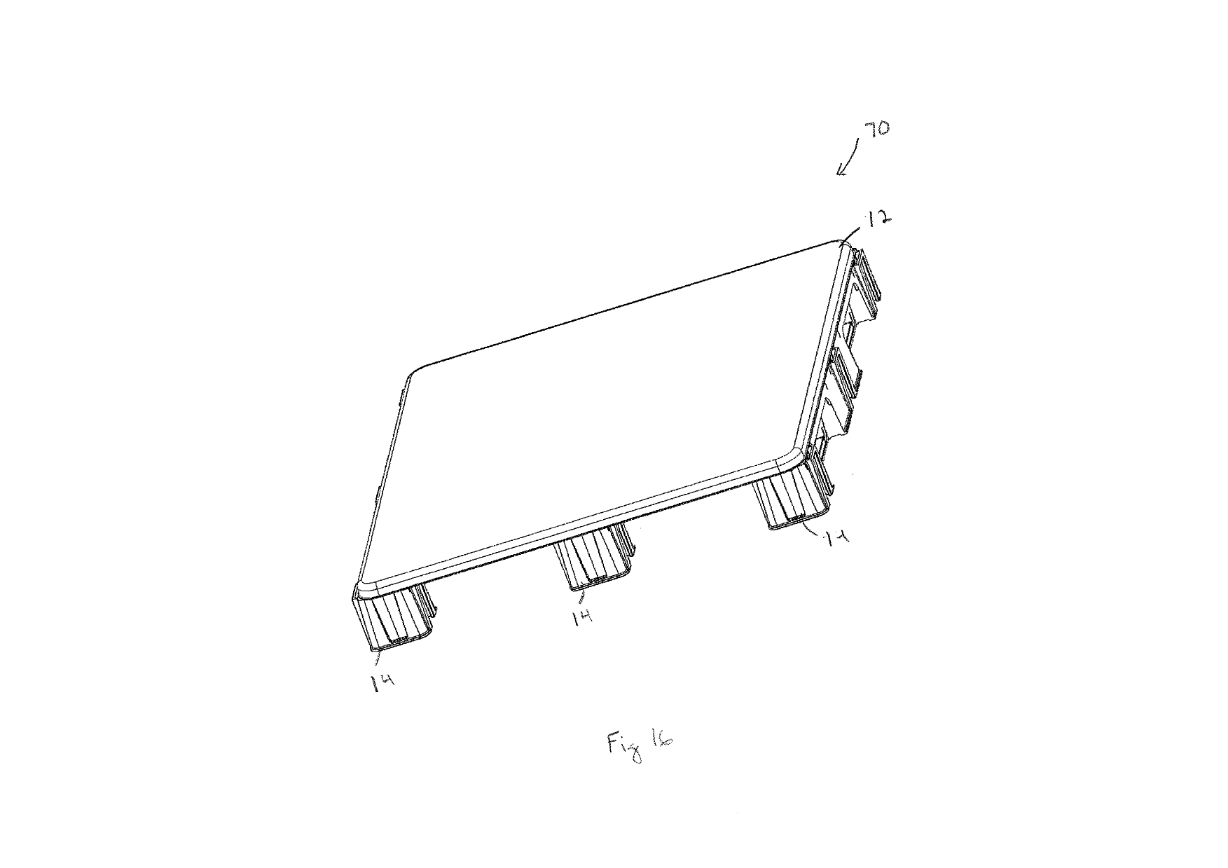

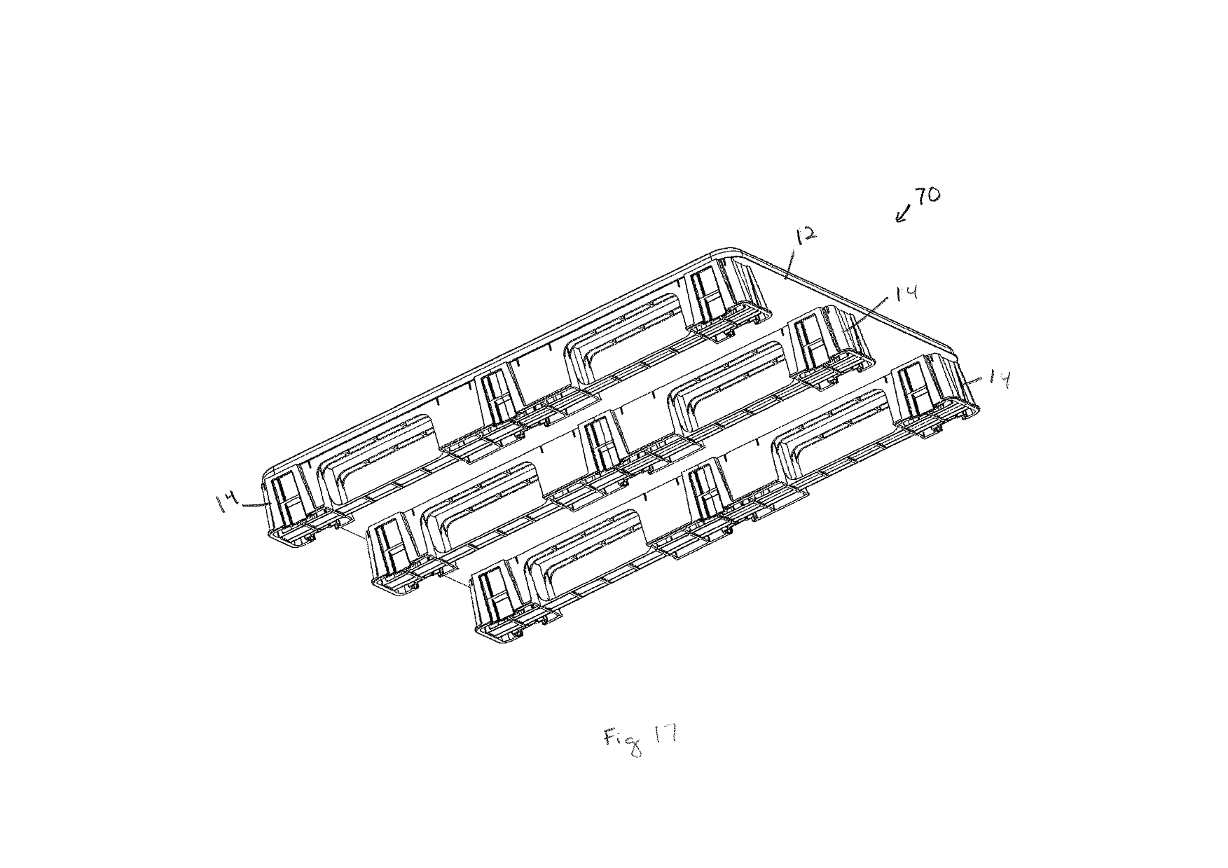

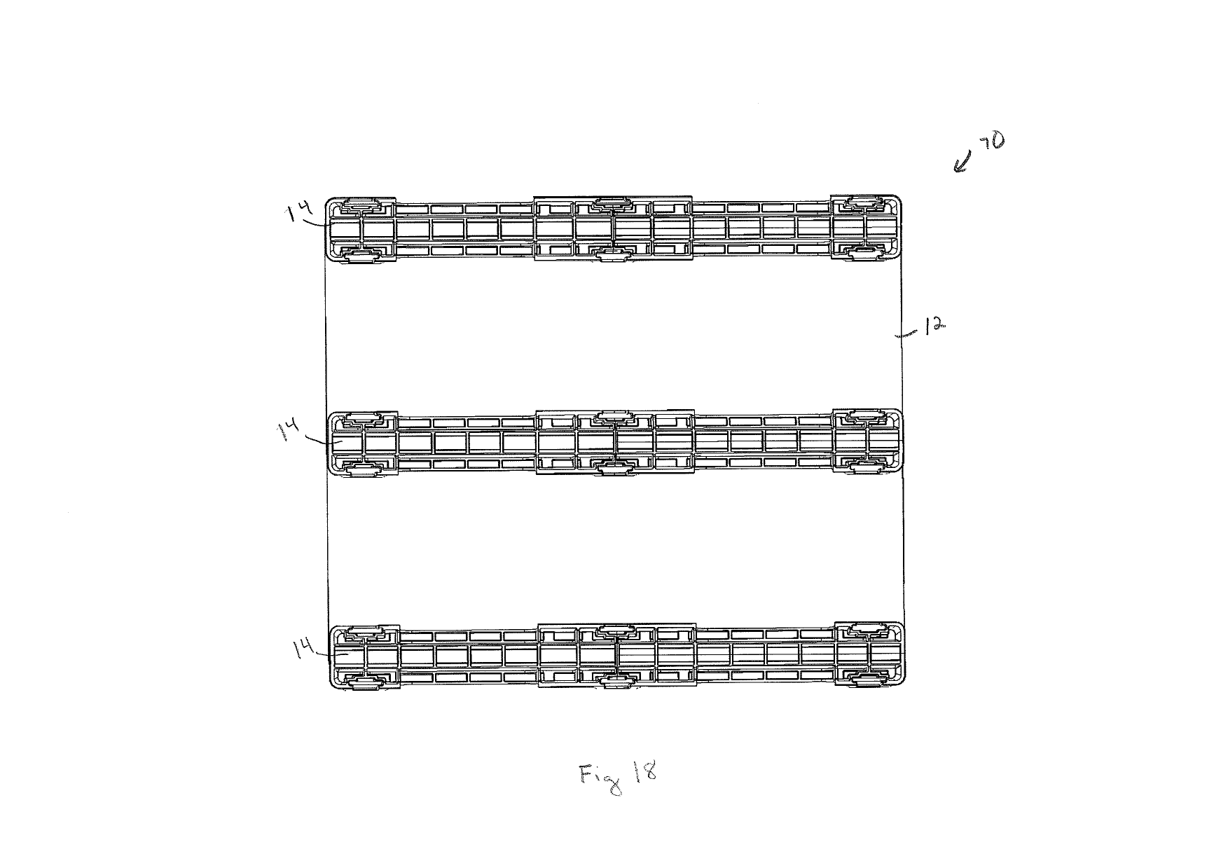

Turning now to FIGS. 16-18, another exemplary pallet 70 is shown. The pallet 70 is substantially the same as the above-referenced pallet 10, and consequently the same reference numerals are used to denote structures corresponding to similar structures in the pallet 70. As illustrated, the pallet 70 includes a deck unit 12 and three supports 14 removably or unremovably coupled to the deck unit. Unlike the pallet 10, the pallet 70 does not include spacers. By removing the spacers, the overall weight of the pallet is reduced, but the pallet 70 retains considerable strength and load-bearing capacity.

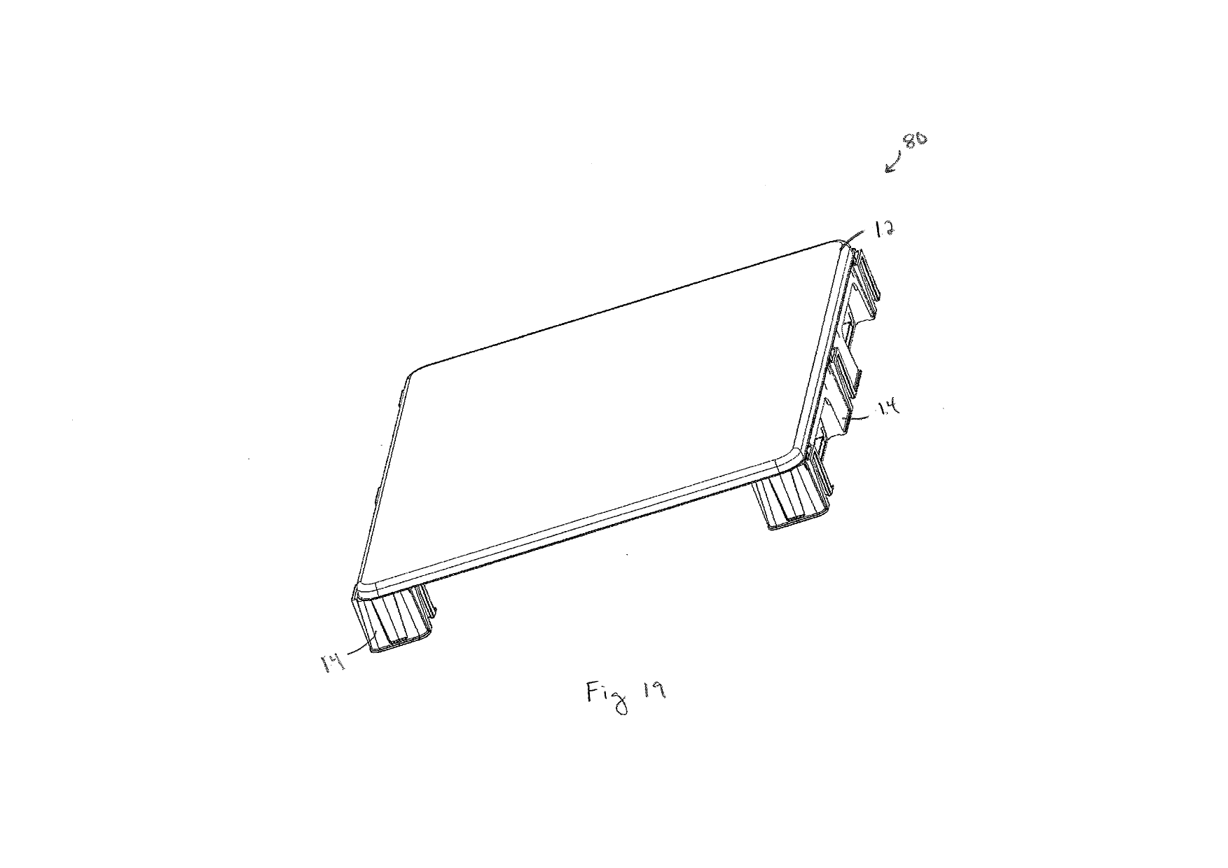

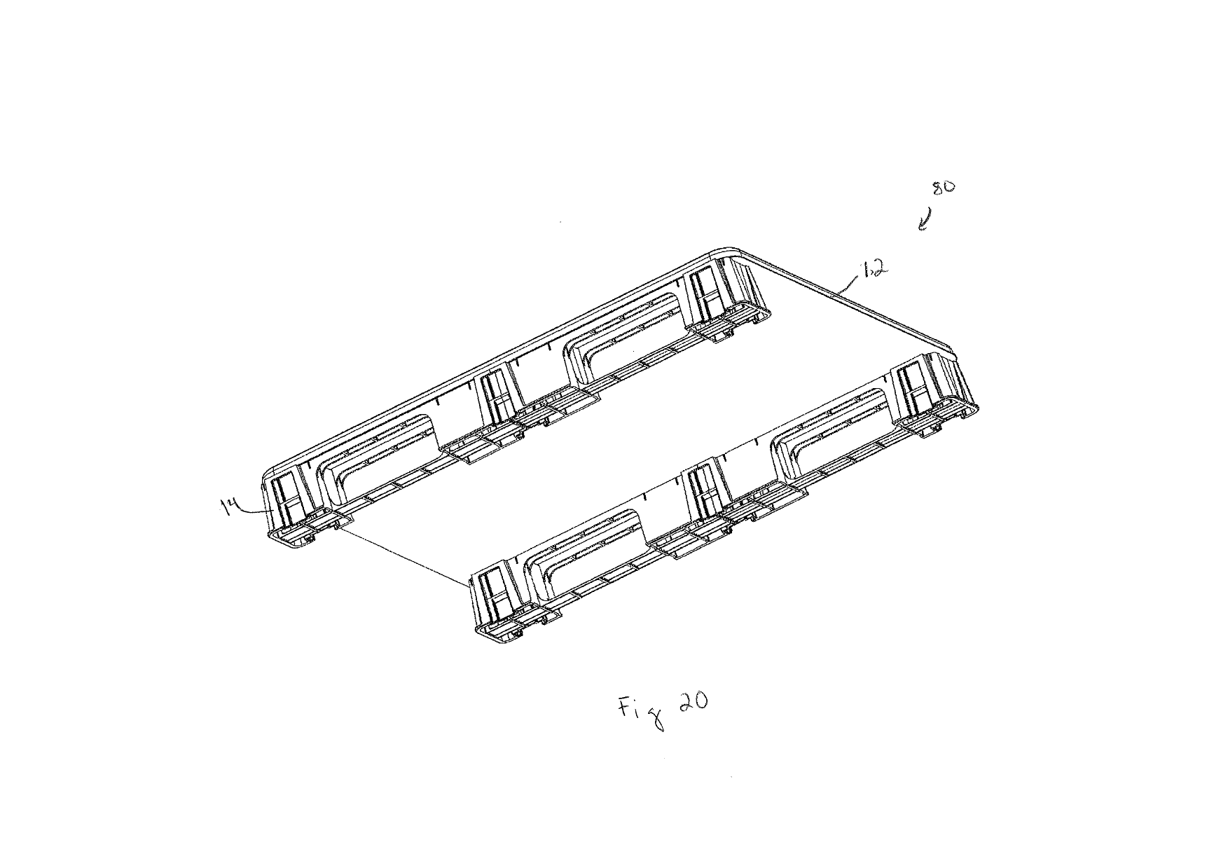

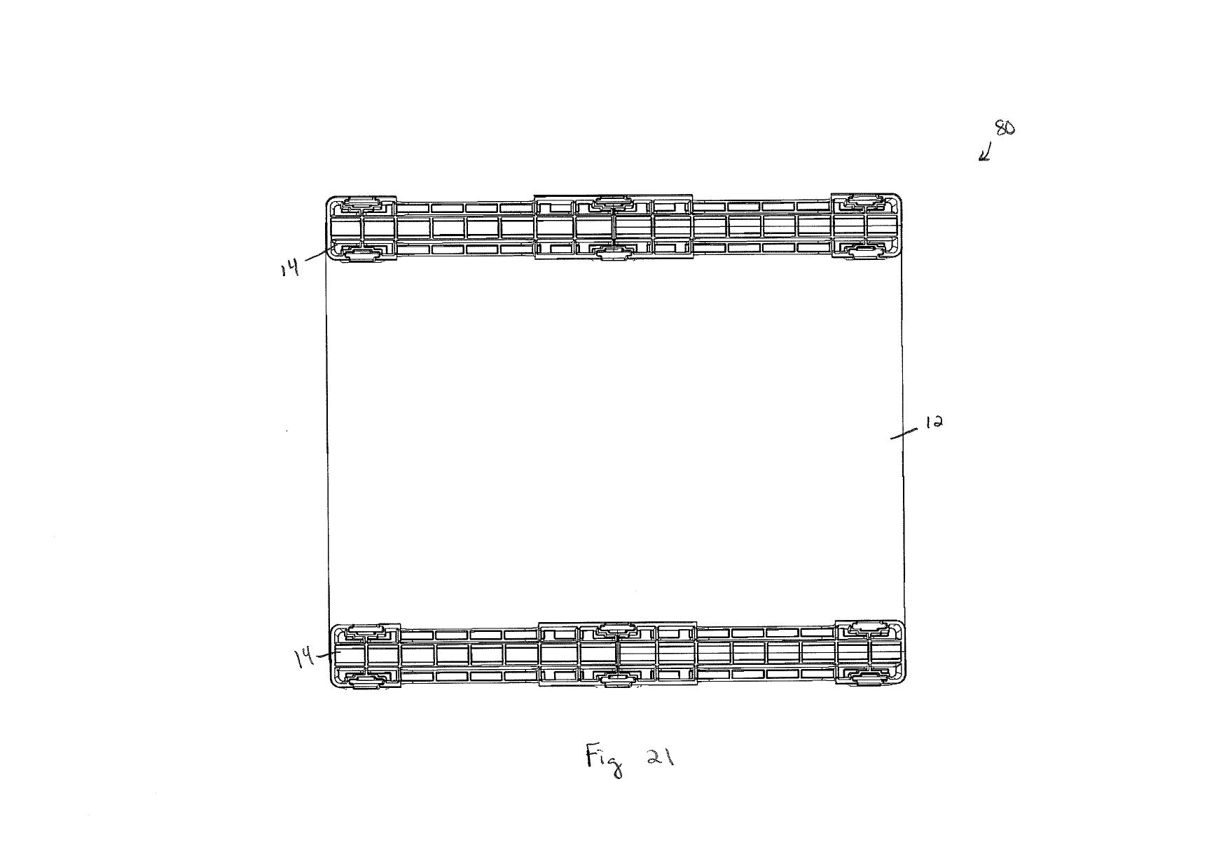

Turning now to FIGS. 19-21, another exemplary pallet 80 is shown. The pallet 80 is substantially the same as the above-referenced pallets 10 and 70, and consequently the same reference numerals are used to denote structures corresponding to similar structures in the pallet 80. As illustrated, the pallet 80 includes a deck unit 12 and two supports 14 removably or unremovably coupled to the deck unit. Unlike the pallet 10, the pallet 80 does not include spacers, and unlike the pallet 70, the pallet 80 includes only two supports. By removing the spacers and one support, the overall weight of the pallet is reduced, but the pallet 80 retains considerable strength and load-bearing capacity.

Although the pallets are described as including two or three supports, it will be appreciated that any suitable number of supports may be used and configured in any suitable manner to form an exemplary pallet. Additionally, as should be appreciated, although spacers are not required, any suitable number of spacers may be included in the pallet and configured in any suitable manner.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A reconfigurable load-bearing article, including:
a deck unit; and
at least two supports configured to be coupled to the deck unit, the supports including at least one spacer receiving member configured to receive and releasably engage a spacer approximately perpendicular to the supports;
wherein the at least two supports are comprised of a polymer.

2. A reconfigurable load-bearing article according to claim 1, wherein the deck unit is comprised of a compressible foam core and a thermoplastic external shell.

3. A reconfigurable load-bearing article according to claim 1, wherein the deck unit includes a tracking device operatively coupled to or disposed within the deck unit.

4. A reconfigurable load-bearing article according to any of claim 1, wherein the at least two supports are removably coupled to the deck unit.

5. A reconfigurable load-bearing article according to claim 1, wherein the at least two supports are unremovably coupled to the deck unit.

6. A reconfigurable load-bearing article according to claim 5, wherein the at least two supports are coupled to the deck unit via a plastic weld.

7. A reconfigurable load-bearing article according to claim 5, wherein the at least two supports are coupled to the deck unit via a mechanical fastener.

8. A reconfigurable load-bearing article according to claim 1, wherein the at least two supports are parallel to and laterally spaced apart from one another.

9. A reconfigurable load-bearing article according to any preceding claim, further including the at least one spacer, wherein the at least one spacer includes a coupling member configured to be coupled to the spacer receiving member.

10. A reconfigurable load-bearing article according to claim 9, wherein the spacer receiving member is a female coupler and the coupling member is a male coupler.

11. A reconfigurable load-bearing article according to claim 1, wherein the article is configured to provide an edge-rackable load-bearing-to-weight ratio of at least 100 to 1.

12. A reconfigurable load-bearing article according to claim 1, wherein the article includes a first support and a second support.

13. A reconfigurable load-bearing article according to claim 12, wherein the at least one spacer is disposed between the first and second supports.

14. A reconfigurable load-bearing article according to claim 13, wherein the article includes a first and second spacer, the first and second spacers being disposed between the first and second supports and being parallel to and laterally spaced apart from one another.

15. A reconfigurable load-bearing article according to claim 1, wherein the article further includes a third support parallel to the first and second supports and laterally spaced apart from the second support so that the first and third supports are on opposite sides of the second support.

16. A reconfigurable load-bearing article according to claim 15, the article further including a first pair of spacers disposed between and coupled to the first support and the second support and a second pair of spacers disposed between and coupled to the second support and the third support.

17. A reconfigurable load-bearing article according to claim 16, wherein the article is configured as a picture frame pallet.

18. A reconfigurable load-bearing article according to claim 16, the article further including fifth and sixth spacers, the fifth spacer being disposed between the first and second supports and the sixth spacer being disposed between the second and third supports.

19. A reconfigurable load-bearing article according to claim 18, wherein the article is configured as a cruciform pallet.

20. A method of making a reconfigurable load-bearing article including:
coupling a deck unit to first and second supports that are parallel to and laterally spaced apart from one another; and
coupling a plurality of spacers between and approximately perpendicular to the first and second supports, wherein the plurality of spacers are removably coupled to the first and second supports;
wherein the plurality of spacers are parallel to and laterally spaced apart from one another.

21. A method according to claim 20, further including:
forming the deck unit of a compressible foam core and a thermoplastic external shell.

22. A method according to claim 21, further including:
coupling a third support to the deck unit at a location parallel to the first and second supports and laterally spaced apart from the second support so that the first and third supports are on opposite sides of the second support.

23. A method according to claim 22, further including:
coupling a plurality of spacers between and approximately perpendicular to the second and third supports, wherein the plurality of spacers are removably coupled to the second and third supports;
wherein the plurality of spacers are parallel to and laterally spaced apart from one another.

24. A method according to claim 23, wherein the plurality of spacers between the first and second supports includes three spacers and the plurality of spacers between the second and third supports includes three spacers.
